(19) United States
(12) Patent Application Publication
(10) Pub. No.: US 2026/0195977 A1
(43) Pub. Date: Jul. 9, 2026

(54) SPATIAL THREE-DIMENSIONAL VIDEO GENERATION FROM TWO-DIMENSIONAL CONTENT

(71) Applicant: Meta Platforms, Inc., Menlo Park, CA (US)

(72) Inventors: Naina Dhingra, Kilchberg (CH); Bo Zhu, Lexington, MA (US)

(21) Appl. No.: 19/441,693

(22) Filed: Jan. 6, 2026

Related U.S. Application Data
(60) Provisional application No. 63/742,813, filed on Jan. 7, 2025.

(51) Int. Cl. G06T 15/20; G06T 7/50

(52) U.S. Cl. CPC G06T 15/205; G06T 7/50

(57) ABSTRACT

Methods and system to generate a 3D representation of a video frame from a single 2D input frame are provided. The system may obtain a 2D input frame including objects. The system may apply a machine learning model including a depth map to utilize the depth map to generate depth content of the objects of the 2D input frame. The system may generate, based on the depth content of the objects and the 2D input frame, a first output frame of the objects. The system may generate, based on the depth content of the objects and the 2D input frame, a second output frame of the objects. The system may provide, by utilizing the first output frame and the second output frame, a 3D representation of the objects of the 2D input frame.

### CROSS-REFERENCE TO RELATED APPLICATIONS

This application claims priority to U.S. Provisional Application No. 63/742,813, filed Jan. 7, 2025, entitled “Spatial Three-Dimensional Video Generation From Two-Dimensional Content,” which is incorporated by reference herein in its entirety.

### TECHNICAL FIELD

This application is directed to generating three-dimensional (3D) imagery, and more particularly, using a two-dimensional (2D) image to generate a 3D representation of the 2D image.

### BACKGROUND

Spatial content (e.g., 3D content) may be generated by, for example, multiple cameras, with one camera simulating a viewpoint of a user's left eye and another camera simulating a viewpoint from a user's right eye. Such cameras may be integrated with a mixed reality (MR) device.

### BRIEF SUMMARY

Some examples of the present disclosure are directed to generating a 3D representation of a video frame from a single 2D video frame. A single 2D video frame may be processed to create two frames, each of which may be altered by translating respective pixels in different directions. The new frames may simulate the original 2D frame from different viewpoints (e.g., left eye and right eye). The altered frames may be combined to create a 3D representation of the 2D frame.

Some exemplary aspects of the present disclosure may generate a 3D representation of a video frame from a single 2D video frame. In this regard, a single 2D video frame may be processed to create two frames, each of which may be altered by translating respective pixels in different directions. A spatial transformer network may be implemented to obtain depth content and disparity content of objects of the 2D video frame. The new frames (e.g., the two created frames) may simulate the original 2D frame from different viewpoints (e.g., left eye viewpoint and right eye viewpoint). The altered frames may be combined to create a 3D representation of the 2D video frame. Several pixels may be processed to determine depth and disparity, thus allowing the 3D representation to provide depth to objects formed by the pixels. Additional processes, such as interpolation and inpainting, may be used in conjunction with translating the pixels.

In one example of the present disclosure, a method is provided. The method may include obtaining a 2D input frame comprising objects. The method may further include applying a machine learning model comprising a depth map to utilize the depth map to generate depth content of the objects of the 2D input frame. The method may further include generating, based on the depth content of the objects and the 2D input frame, a first output frame of the objects. The method may further include generating, based on the depth content of the objects and the 2D input frame, a second output frame of the objects. The method may further include providing, by utilizing the first output frame and the second output frame, a 3D representation of the objects of the 2D input frame.

In another example of the present disclosure, an apparatus is provided. The apparatus may include one or more processors and a memory including computer program code instructions. The memory and computer program code instructions are configured to, with at least one of the processors, cause the apparatus to at least perform operations including obtaining a 2D input frame comprising objects. The memory and computer program code are also configured to, with the processor(s), cause the apparatus to apply a machine learning model comprising a depth map to utilize the depth map to generate depth content of the objects of the 2D input frame. The memory and computer program code are also configured to, with the processor(s), cause the apparatus to generate, based on the depth content of the objects and the 2D input frame, a first output frame of the objects. The memory and computer program code are also configured to, with the processor(s), cause the apparatus to generate, based on the depth content of the objects and the 2D input frame, a second output frame of the objects. The memory and computer program code are also configured to, with the processor(s), cause the apparatus to provide, by utilizing the first output frame and the second output frame, a 3D representation of the objects of the 2D input frame.

In yet another example of the present disclosure, a computer program product is provided. The computer program product may include at least one non-transitory computer-readable medium including computer-executable program code instructions stored therein. The computer-executable program code instructions may include program code instructions configured to obtain a 2D input frame comprising objects. The computer program product may further include program code instructions configured to apply a machine learning model comprising a depth map to utilize the depth map to generate depth content of the objects of the 2D input frame. The computer program product may further include program code instructions configured to generate, based on the depth content of the objects and the 2D input frame, a first output frame of the objects. The computer program product may further include program code instructions configured to generate, based on the depth content of the objects and the 2D input frame, a second output frame of the objects. The computer program product may further include program code instructions configured to provide, by utilizing the first output frame and the second output frame, a 3D representation of the objects of the 2D input frame.

In an example, a method may include obtaining an input frame comprising one or more objects; applying a model to obtain a depth map of the one or more objects of the input frame; generating, based on the depth map and from the input frame, a first output frame of the one or more objects; generating, based on the depth map and from the input frame, a second output frame of the one or more objects; and providing, using the first output frame and the second output frame, a three-dimensional representation of the one or more objects of the input frame.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Certain features of the subject technology are set forth in the appended claims. However, for purpose of explanation, several examples of the subject technology are set forth in the following figures.

FIG. 1 illustrates a plan view of an example embodiment of a frame, in accordance with aspects of the present disclosure.

FIG. 2 illustrates a block diagram of an example embodiment of a system utilized to transform a 2D frame into a 3D representation of the 2D frame, in accordance with aspects of the present disclosure.

FIG. 3 illustrates a flow diagram for converting 2D frames to a 3D representation of the 2D frames.

FIG. 4 illustrates a plan view of an example embodiment of a frame, showing objects in a prior frame translated relative to their position in the prior frame, in accordance with aspects of the present disclosure.

FIG. 5 illustrates a plan view of an example embodiment of a frame, showing objects in a prior frame translated relative to their position in the prior frame, in accordance with aspects of the present disclosure.

FIG. 6 illustrates a plan view of an example of a 3D representation of the objects, in accordance with aspects of the present disclosure.

FIG. 7 illustrates an example flowchart illustrating operations for devices that may utilize a 2D frame to generate 3D representation, in accordance with aspects of the present disclosure.

FIG. 8 is a diagram of an exemplary network environment in accordance with various example aspects discussed herein.

FIG. 9 illustrates a block diagram of an example communication device in accordance with various example aspects discussed herein.

FIG. 10 illustrates a block diagram of an example computing system in accordance with various example aspects discussed herein.

FIG. 11 illustrates an example of an artificial reality system comprising a headset, in accordance with an example of the present disclosure.

FIG. 12 illustrates another artificial reality system comprising a headset, in accordance with an example of the present disclosure.

FIG. 13 illustrates an example of a machine learning framework in accordance with one or more examples of the present disclosure.

FIG. 14 illustrates an exemplary process to facilitate generation of a 3D representation of a video frame based on a 2D input frame in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary,” as used herein, is not provided to convey any qualitative assessment, but instead merely to convey an illustration of an example. Thus, use of any such terms should not be taken to limit the spirit and scope of embodiments of the present application. It is to be understood that the methods and systems described herein are not limited to specific methods, specific components, or to particular implementations.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented Reality (AR)/Virtual Reality (VR)/Mixed Reality (MR).

As referred to herein, warp, warping, or the like may refer to distorting an image(s) geometrically based on transferring of pixels to new locations in an image(s) by transformations (e.g., rotation, scaling, shear, distance adjustments, inpainting of pixels to fill voids for moved pixels) to reposition pixels in an image(s) and/or for a new image(s).

As referred to herein, an image depth may refer to a distance of a pixel(s) of an image(s) from a sensor or user (e.g., a distance of the pixel(s) in relation to a location of the sensor or location of the user).

A depth map may include one or more images in which pixel values may represent the distance(s) of objects in the images from a sensor (e.g., camera, other device) and/or user.

As referred to herein, inpainting may be a technique to reconstruct and/or fill in voids (e.g., missing) or portions/sections of missing pixels of an image(s) by utilizing information (e.g., pixel data) from a surrounding area (e.g., neighboring pixels) to generate new pixels.

As referred to herein, interpolation may be a technique of determining/estimating new pixel values to fill in voids of missing pixels (e.g., no pixels) that may be due to, for example, resizing, rotating, moving/transferring and/or distorting pixels of an image by analyzing neighboring/surrounding pixels to determine color and/or brightness for the missing pixels and to apply the new pixels to the voids. In some other examples, interpolation may be a process or technique to estimate/determine unknown data points that fall between known data points.

As referred to herein, a frame, or video frame may refer to an image (e.g., a single static image, still image/photo) within, or associated with, a sequence that may create motion for a video. In this regard, each frame, video frame, or the like may be associated with an image, photo, or picture at a specific moment or time.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only, and is not intended to be limiting.

It is to be appreciated that certain features of the disclosed subject matter which are, for clarity, described herein in the context of separate embodiments, can also be provided in combination in a single embodiment. Conversely, various features of the disclosed subject matter that are, for brevity, described in the context of a single embodiment, can also be provided separately, or in any sub-combination. Further, any reference to values stated in ranges includes each and every value within that range. Any documents cited herein are incorporated herein by reference in their entireties for any and all purposes.

It is to be understood that the methods and systems described herein are not limited to specific methods, specific components, or to particular implementations. It is also to be understood that the terminology used herein is for the purpose of describing particular embodiments only and is not intended to be limiting.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim. References in this description to “an example”, “one example”, or the like, may mean that the particular feature, function, or characteristic being described is included in at least one example of the present embodiments. Occurrences of such phrases in this specification do not necessarily all refer to the same example, nor are they necessarily mutually exclusive.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

### Exemplary System Operation

The present disclosure is directed to generating spatial output (e.g., spatial video output, stereo output, 3D content) when provided with 2D content (e.g., mono content). In particular, a 2D frame (e.g., still image, frame from motion images and/or video) may be transformed to create a 3D representation of the 2D frame. In one or more implementations, the pixels of the 2D frame may be processed and assigned a depth. Based in part on the depth, the disparity for each pixel(s) may be determined. Using the disparity for the pixels, multiple frames, or images, may be generated (e.g., output) from the original (e.g., input) 2D image. One of the frames may be generated for a left eye of a user, while the other frame may be generated for a right eye of the user. In one or more implementations, a spatial transformer network for warping is used to process the pixels and generate an image for the left eye and for the right eye. Using a spatial transformer network, the use of inpainting may be reduced and the output stereo video may be relatively more consistent and stable, as compared to other approaches (e.g., forward warping). Also, the location(s) that may utilize inpainting is significantly reduced due to the warping effect facilitated by the spatial transformer network. Beyond its use for warping, the spatial transformer network is also employed to generate an inpainting mask, targeting a smaller portion of a scene. This dual functionality enhances the efficiency of the inpainting process, resulting in videos that are both temporally stable and visually comfortable for users to watch.

Using the disparity data, pixels determined to be relatively closer to the user may be translated, or shifted, relatively more than pixels determined to be relatively further from the user. Accordingly, objects (e.g., content within the frame created by respective pixels) may be translated by different distances based on a determination whether the objects, generated by respective pixels, are closer to or further from the user. The exemplary process may be repeated on sequential frames of a 2D video to generate 3D content (e.g., 3D video) from the 2D video. Beneficially, 3D content may be generated based on creating spatial frames for each 2D frame(s) without the use of multiple cameras positioned at different viewpoints (e.g., replicating position of a user's eyes).

While transformation of pixels is generally used to create the 3D content, other complementary processes may be used. For example, for an object in a 2D frame, a system or apparatus described herein may not be able to exactly determine what is “behind” the object and an interpolation operation may be used. In this regard, when pixels representing the object are translated to generate a frame (e.g., content for the user's left eye or right eye), the pixel data (e.g., Red, Green, Blue (RGB) value of the pixels) is translated and pixel values may fill a “void” where pixels of the object were previously located and no longer occupying. This may include using an average value of nearby pixels. Other approaches (e.g., Gaussian, blurring) may be used to create pixel data and fill the voids with the pixel data. Additionally, near the borders, or edges, of a frame, a system or apparatus described herein may utilize inpainting to fill voids of translated objects in a generated frame when backward warping may not be utilized. The inpainting operation may utilize a mask to denote locations along the border in which inpainting may be applied. The pixel transformation approach may be substantially utilized to provide enhanced quality 3D content, while other processes (e.g., interpolation, inpainting) may be limited in use, resulting in less artifacts and flickering during presentation of the 3D content.

The disclosed subject matter may be extended into different use cases, such as bringing social media content into a MR/AR/VR experience, conversion of legacy content (e.g., legacy television shows, movies, or personal videos) into a MR/AR/VR experience, or other uses of content that may be in a 2D format into a MR/AR/VR experience.

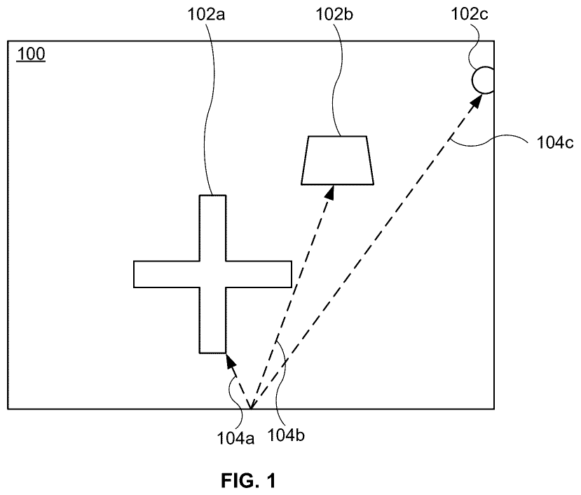

These and other embodiments are discussed below with reference to FIGS. 1-14. However, those skilled in the art will readily appreciate that the detailed description given herein with respect to these Figures is for explanatory purposes only and should not be construed as limiting.

FIG. 1 illustrates a plan view of an example embodiment of a frame 100, in accordance with aspects of the present disclosure. The frame 100 may take the form of an image (e.g., still image) or one of several frames of a motion frame or motion images (e.g., video). As shown, the frame 100 may include several objects created by respective pixels. For example, the frame 100 may include an object 102a, an object 102b, and an object 102c. The objects 102a, 102b, and 102c are shown as shapes. However, the objects 102a, 102b, and 102c may be representative of various organic and inorganic subjects, background content, etc. Also, the frame 100 may take the form of a 2D frame. Accordingly, each of the objects 102a, 102b, and 102c make take form of a 2D object, each with a respective length and width, for example.

While the frame 100 may present the objects 102a, 102b, and 102c in 2D format, the relative positions of the objects 102a, 102b, and 102c (and in particular, their respective pixels) in the frame 100 may indicate different depths, corresponding to different distances from a user viewing the frame 100. For example, the object 102a, the object 102b, and the object 102c is located at a depth 104a, a depth 104b, and a depth 104c, respectively. As shown, the depth 104b is greater than the depth 104a, and the depth 104c is greater than each of the depth 104a and the depth 104b. Conversely, the depth 104b is less than the depth 104c, and the depth 104a is less than each of the depth 104b and the depth 104c. Accordingly, a user may perceive the object 102a as being closer than each of the objects 102b and 102c, as well as perceive the object 102b being closer than the object 102c. In this example, the user may perceive the object 102c as being farther away from the user in relation to the object 102a and the object 102b.

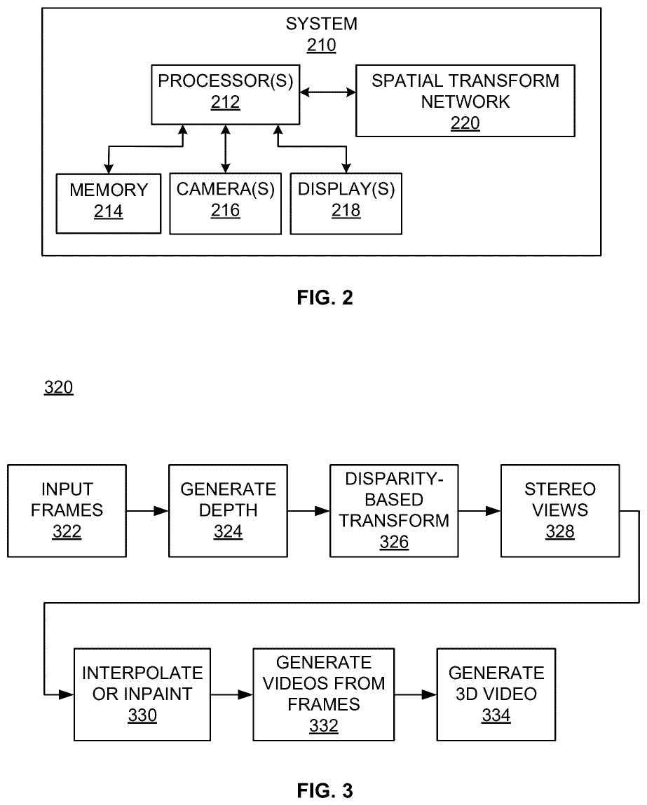

FIG. 2 illustrates a block diagram of an example embodiment of a system 210 utilized to transform a 2D frame into a 3D representation of the 2D frame, in accordance with aspects of the present disclosure. As non-limiting examples, the system 210 may take the form of a MR device (e.g., AR device, VR device), a mobile wireless communication device (e.g., smartphone, tablet computing device), a desktop computing device, or a laptop computing device. The system 210 may include one or more processers 212. As non-limiting examples, the one or more processors 212 may include a central processing unit (CPU), a graphics processing unit (GPU), one or more microcontrollers, one or micro-electromechanical systems (MEMS) controllers, or a combination thereof.

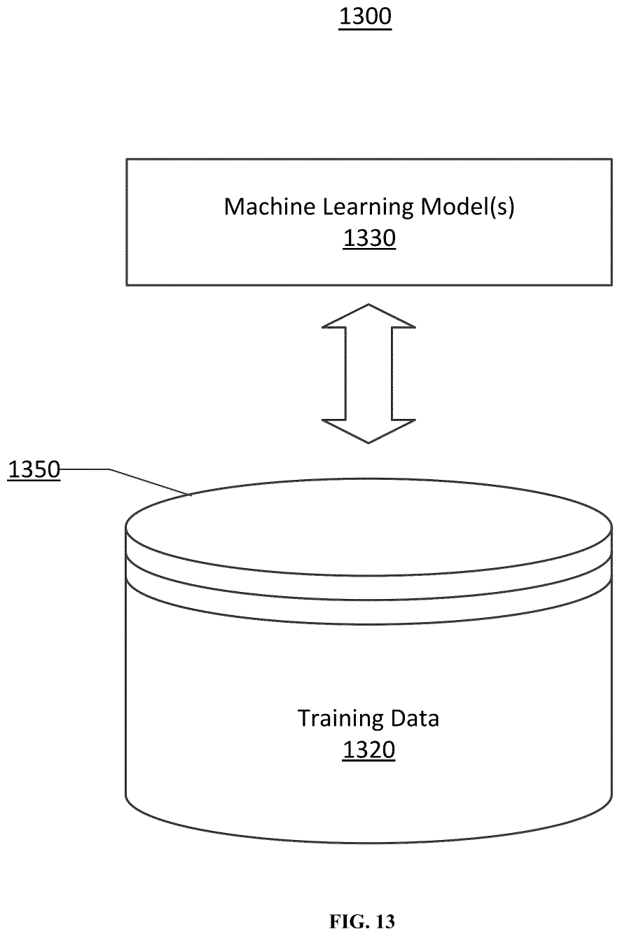

The system 210 may further include memory 214, in the form of one or more memory circuits. The memory 214 may include non-volatile memory (e.g., read-only memory), volatile memory (e.g., random access memory), or a combination thereof. The memory 214 may store instructions (e.g., executable instructions) that are executed by the one or more processors 212 to convert 2D content to 3D content, as shown and/or described herein. The memory 214 may also store one or more artificial intelligence (AI) models and/or machine learning (ML) models (e.g., machine learning model(s) 1330 of FIG. 13), training data (e.g., training data 1320 of FIG. 13), depth maps, disparity data, etc. In some examples, the one or more processors may implement/execute the models to facilitate conversion of 2D content to 3D content.

Optionally, the system 210 may include one or more cameras 216, one or more displays 218 and a spatial transform network 220. The system 210 may utilize one or more cameras 216 to obtain/capture 2D content (e.g., 2D frames). When the 2D content is converted by the system 210 to 3D content, the system 210 may utilize the one or more displays 218 to present the 3D content to, for example, one or more users. In some examples, the system 210 may provide the converted 3D content to one or more other communication devices (e.g., UE 900, computing system 1000, artificial reality system 1100, HMD 1200). In some examples, the spatial transform network 220 may transform aspects of 2D content (e.g., 2D images, 2D video frames) by shifting pose, size and/or orientation of the 2D content and/or to warp the 2D content to facilitate the generation of the 3D content (e.g., 3D images, 3D video frames). The spatial transform network 220 may be utilized for a type of backward warping, which may be used to warp an image frame. The spatial transformer network may include affine transformation and bilinear interpolation.

FIG. 3 illustrates a flow diagram 320 for converting 2D frames to a 3D representation of the 2D frames, in accordance with aspects of the present disclosure. At block 322, frames are received. The frames may include frames that form video, with each frame being in 2D format. For example, the 2D frames may be received by being captured and/or accessible by a device.

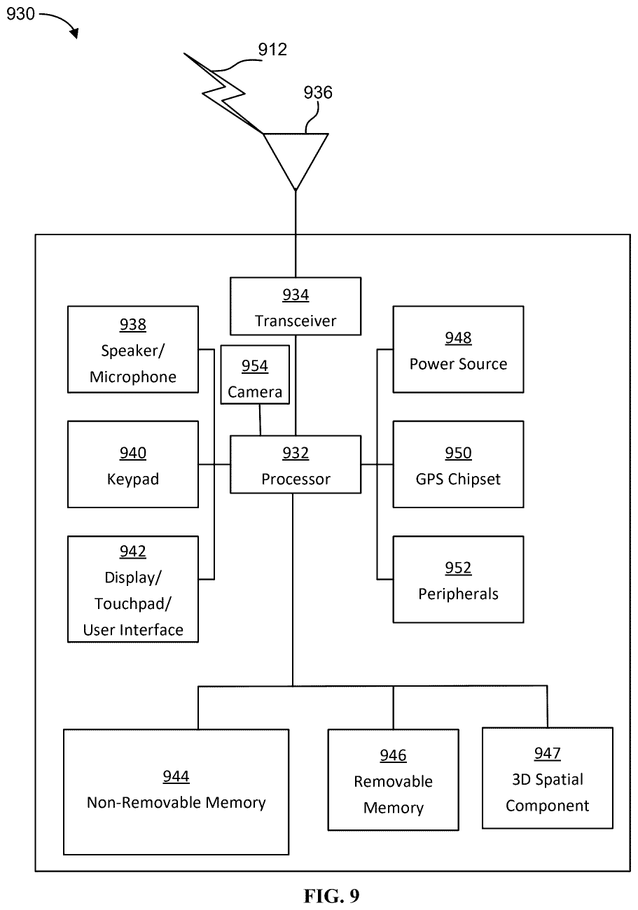

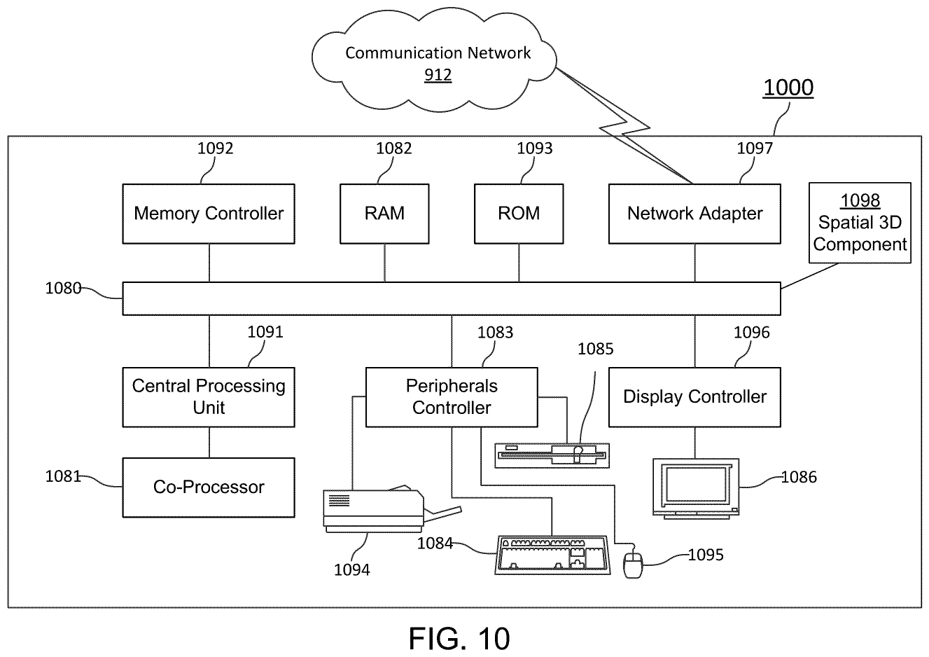

At block 324, depth is generated for each received frame in 2D format. This may include utilizing a model to generate a depth map. In some examples, the model may be the machine learning model(s) 1330, which may generate the depth map. In some other examples, the model may be, or may be implemented by, the spatial 3D component 947 of FIG. 9, and/or the spatial 3D component 1098 of FIG. 10. The depth map may provide an estimation of depth of the pixels in the 2D frame. For example, the depth map may provide the relative depth of the pixels. A disparity map may be generated from, or based on, the model (e.g., machine learning model(s) 1330) and the disparity map may provide the relative disparity which may indicate how much distance a pixel(s) should move, or be moved. The depth map may also include relative depth estimation of pixels. Various models (e.g., depth models (e.g., large language models (LLMs) for determining depth estimates of pixels) may be used to estimate depth. In some examples, the machine learning model(s) 1330 and/or the spatial 3D component 947 or the spatial 3D component 1098 may include a depth model(s) to determine the relative depth (e.g., distance) of pixels. When the depth of the pixels is determined (e.g., estimated), the depth of objects (created from the pixels) in the frame may also be determined.

At block 326, the pixels undergo a disparity-based transformation. This may include a spatial transformer network utilized to determine the transformation for pixels. In some examples, the spatial transformer network may be the spatial transform network 220. In some other exemplary aspects, the 3D spatial component 947 and/or the 3D spatial component 1098 may perform functions of the spatial transform network. In yet some other example aspects, the machine learning model(s) 1330 may perform functions analogous to the spatial transformer network. As an example, the spatial transformer network may include a backward warping operation that maps each translated pixel generated in a new (output) frame (e.g., output for 3D/stereo) back to the same pixel in the source (input) frame (e.g., original 2D frame). The backward warping is a type of warping (e.g., a warping technique), which may help warp the pixels in an image. In the example aspects of the present disclosure, the spatial transform network 220 may perform the backward warping. In this manner, the spatial transform network 220 may provide spatial transformer based warping to facilitate generation of spatial video. The disparity refers to the distance between the locations of a pixel in two output frames, as viewed from different viewpoints (e.g., left eye versus right eye). The disparity may create depth. For example, for a pixel in a 2D frame, a first generated output frame translates the pixel in one direction from the original position for one viewpoint (e.g., left-eye view), and a second generated output frame translates the pixel in another (e.g., opposite) direction from the original position for another viewpoint (e.g., right-eye view). The spatial transform network 220 may determine how much to move the position of a pixel(s) for the left eye view and the right eye view based on analyzing the disparity map, which may indicate the relative disparity of how much distance a pixel(s) should be moved. The spatial transform network may utilize the same distance to move a pixel(s) for both directions (e.g., left eye view direction and right eye view direction). The left-eye and right-eye view are synthesized, by warping the input (e.g., original image/frame) view with respect to the estimated depth on a frame-by-frame basis in both the directions (e.g., left eye view direction and right eye view direction). Generating both left and right views may reduce occluded regions in only one side and hence reduce artifacts in side by side format. The spatial transform network may use disparity in the form of affine transformation and warp using bilinear interpolation. For example, the affine transformation and the bilinear interpolation provided by the spatial transform network 220 may warp a pixel(s). A model (e.g., machine learning model(s) 1330) such as, for example, a depth model may generate the depth and disparity for an RGB image.

The disparity is the sum of translational movement in each respective direction (e.g., left eye direction, right eye direction). The disparity d may be determined by

$$d = a * \frac{1}{z} - b \qquad Eq . 1$$

where a is the perceived deepness in the scene, Z is the depth estimate (e.g., determined from block 324), and b is the positioning of the scene relative to the screen plane. The disparity d may be determined by the spatial transform network. From Eq. 1, it may be shown that the disparity is inversely proportional to the depth estimate

$$d ∝ \frac{1}{z} . \qquad Eq . 2$$

Accordingly, when the depth of the pixel is estimated to be relatively high, the disparity is relatively low, and conversely, when the depth of the pixel is estimated to be relatively low, the disparity is relatively high. In some examples, the depth of the pixel may be determined by a model (e.g., machine learning model(s) 1330) such as a depth model.

The spatial transformer network may be used in a similar manner on additional pixels. Also, when the transformation of a pixel from the source (input) frame to the new (output) frame is less than or equal to a baseline distance (e.g., a threshold distance), the spatial transformer network is used. Using a baseline distance may maintain higher quality 3D content. For example, when the baseline distance is small, the spatial transformer network (e.g., spatial transform network 220) based backward warping may be utilized and may provide good results. Other operations described below are utilized when the disparity is greater than the baseline distance (e.g., threshold distance).

At block 328, the stereo views are generated. From a 2D frame, the stereo views represent two frames from two different viewpoints of the 2D frame. The stereo views may be combined to form a 3D representation of the 2D frame. The two different viewpoints of the 2D frame may be a right eye viewpoint and a left eye viewpoint. The stereo views may represent a depiction of a single 3D image when viewed via a device, even though the stereo views may be separate and distinct stereo views (e.g., the two eyes may view slightly different perspectives causing the stereo views to be perceived as having depth enabling a user to see/view the stereo views with spatial dimension (e.g., 3D). In some examples, a processor (e.g., one or more processors 212, processor 932, coprocessor 1081, controller 1104, processor 1204) may generate the stereo views. In some other examples, the spatial 3D component 947, the spatial 3D component 1098 and/or the machine learning model(s) 1330 may generate the stereo views.

At block 330, interpolation and/or inpainting may be applied to the frames for stereo views in block 328. In some examples, a spatial transform network (e.g., spatial transform network 220) may perform the interpolation and/or inpainting. In some other examples, other components (e.g., spatial 3D component 947, spatial 3D component 1098, machine learning model(s) 1330) may perform the interpolation and/or inpainting. Interpolation may be applied to pixels that included pixel data in the original 2D frame but no longer include pixel data, due to translation of some pixels. For example, when an object (formed from pixels) is translated in the stereo frame, pixels formerly used to show the object may no longer include pixel data. The inpainting may reconstruct or fill in voids (e.g., missing) portions/sections of an image by utilizing information (e.g., pixel data) from a surrounding area (e.g., neighboring pixels) to generate new pixels. Interpolation may be applied to provide pixel data to these pixels. Additionally, when the transformation of a pixel from the 2D source frame to the new (output) frame is greater than a threshold distance, interpolation may be applied to the new frame. Inpainting may be applied at or along the border, or edge, of the new frame. For example, in locations at or along the border, inpainting may be utilized, particularly when the 2D source frame has little or no pixel data.

At block 332, video is generated from the frames. For example, a pair of output frames, each generated from the same input frame (e.g., a 2D input frame), are used to create 3D content. At block 334, 3D video is generated. In some examples, a processor(s) (e.g., one or processors 212, processor 932, coprocessor 1081, controller 1104, processor 1204) may generate the 3D video. In some other examples, other components (e.g., spatial 3D component 947, spatial 3D component 1098, machine learning model(s) 1330) may generate the 3D video. The 3D video may be a pair of 3D videos associated with a left eye video view and a right eye video view. The 3D video is generated based on successive pairs of output frames. The pairs of 3D videos may be presented to a viewpoint of a user for the right eye and the left eye which when viewed (e.g., simultaneously) by both eyes may cause the right and left eyes of the user to see/view the pairs of 3D videos as 3D content. The pairs of 3D videos may be presented to a user via a display (e.g., display 1086, display 1114, display 1208) and/or user interface (e.g., display/touchpad/user interface 942).

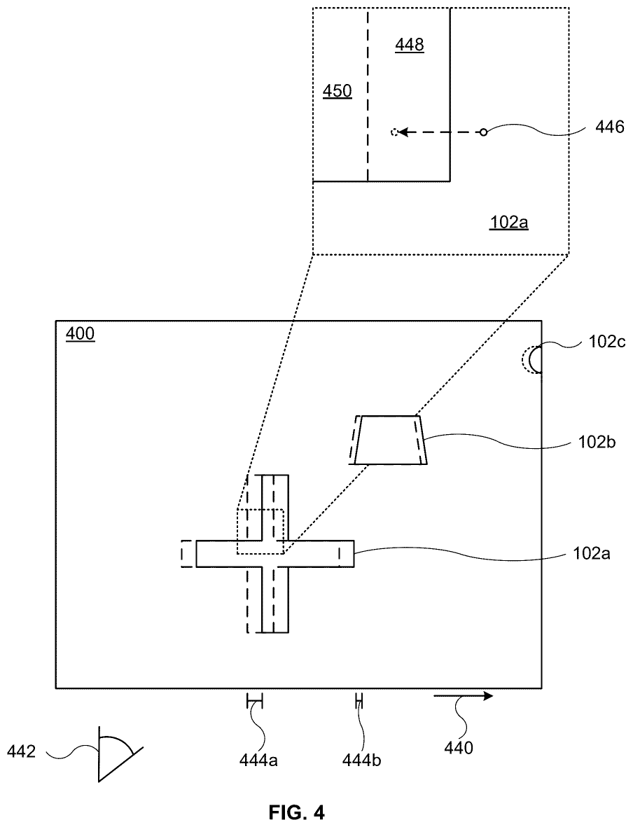

FIG. 4 illustrates a plan view of an example embodiment of a frame 400, showing objects in a prior frame translated relative to their position in the prior frame, in accordance with aspects of the present disclosure. The frame 400 may take the form of an output frame generated from the frame 100 (e.g., input frame) shown in FIG. 1. The frame 100 may be a 2D frame (e.g., a 2D video frame), for example, associated with a captured scene. As shown, respective pixels of each of the objects 102a, 102b, and 102c are translated in a direction of an arrow 440. The dotted lines next to or superimposed on the objects 102a, 102b, and 102c show the original position of the respective pixels of the objects 102a, 102b, and 102c, which is also the same position of the respective pixels of the objects 102a, 102b, and 102c shown in FIG. 1. The frame 400 may be used for viewing by an eye 442 (e.g., left eye) of a user. Accordingly, the frame 400 may be referred to as a left-eye frame.

Although respective pixels of the each of the objects 102a, 102b, and 102c are generally translated in the same direction, the respective pixels of the each of the objects 102a, 102b, and 102c may be translated by different distances. For example, the object 102a (represented by its pixels) is translated by a distance 444a and the object 102b (represented by its pixels) is translated by a distance 444b. As shown, the distance 444b is less than the distance 444a. Based on the depth of the pixels of the object 102a being less than the depth of the pixels of the object 102b, the object 102a is perceived as being closer to the eye 442 (e.g., a left eye 442). Based on Eq. 1, the distance 444a (a component of the disparity) is greater than the distance 444b. Also, the object 102c (represented by its pixels) may be translated by a distance (not shown in FIG. 4) that is less than each of the distance 444a and the distance 444b. In some examples, the spatial transform network 220 may translate the distances (e.g., distance 444a, the distance 444b, etc.) of the objects (objects 102a, 102b, 102c) in the direction. In some other examples, the spatial 3D component 947, the spatial 3D component 1098 and/or the machine learning model(s) 1330 may translate the distances of the objects in the direction.

Also, as shown in the enlarged view, a pixel 446 (representative of several additional pixels) is used to generate the object 102a. The pixel 446 is translated by the distance 444a. Using backward warping, the position of the pixel 446 may be sourced back to the initial position in the original frame (e.g., the frame 100 shown in FIG. 1). In this regard, the backward warping may be utilized to warp an image and to determine/obtain the pixel value from the base (e.g., original) image. A similar operation may be performed for respective pixels corresponding to the objects 102a, 102b, and 102c.

Further, a region 448 proximate to the object 102a represents content that was “behind” the object 102a in the original location of the object 102a (in FIG. 1). The region 448 may also correspond to a location of the object 102a in a prior frame (e.g., the frame 100 shown in FIG. 1) that is no longer occupied by pixels of the object 102a in the frame 400. In this regard, the region 448 may be associated with a void(s) (e.g., missing pixels). An inpainting operation may be utilized to fill the values of pixels in the region 448 with pixel data. As an example, a region 450 adjacent to the region 448 may be selected and an average value of pixels in the region 450 may be used as pixel data, and the average pixel value may be assigned to pixels in the region 448 to fill in pixels, for the missing pixels, in the region 448. As shown, the region 450 is part of the frame 400 and the interpolation operation may be performed spatially. In some examples, the spatial transform network 220 may perform the interpolation operation. In some other examples, the spatial 3D component 947, the spatial 3D component 1098 and/or the machine learning model(s) 1330 may perform the interpolation operation.

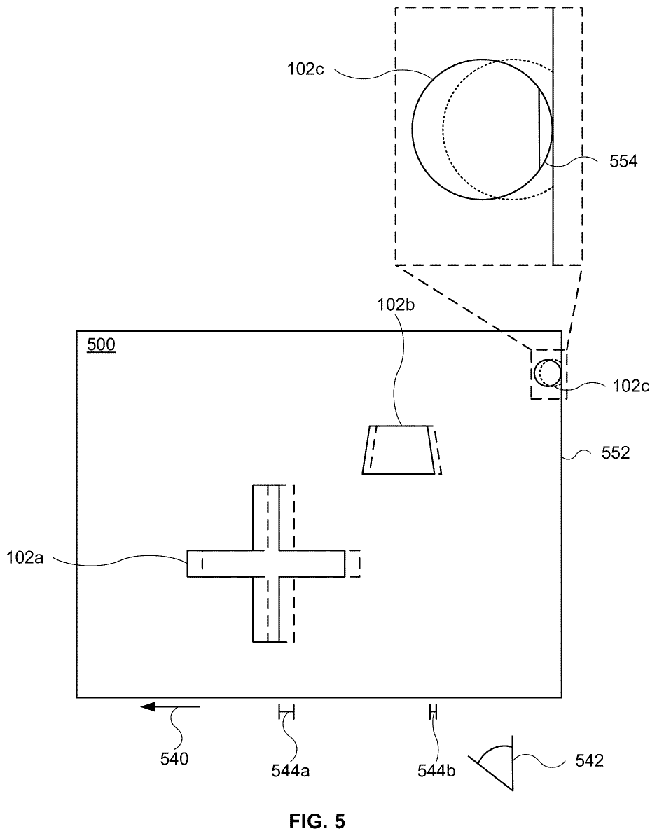

FIG. 5 illustrates a plan view of another example embodiment of a frame 500, showing objects in a prior frame translated relative to their position in the prior frame, in accordance with aspects of the present disclosure. The frame 500 may take the form of an output frame generated from the frame 100 (e.g., input frame) shown in FIG. 1. The frame 100 may be a 2D frame (e.g., a 2D video frame), as described above. As shown, respective pixels of each of the objects 102a, 102b, and 102c are translated in a direction of an arrow 540, which is opposite to the direction of the arrow 440 shown in FIG. 4. The dotted lines next to or superimposed on the objects 102a, 102b, and 102c show the original position of the respective pixels of each of the objects 102a, 102b, and 102c, which is also the same position of the respective pixels of each of objects 102a, 102b, and 102c shown in FIG. 1. The frame 500 may be used for viewing by an eye 542 (e.g., right eye) of a user. Accordingly, the frame 500 may be referred to as a right-eye frame.

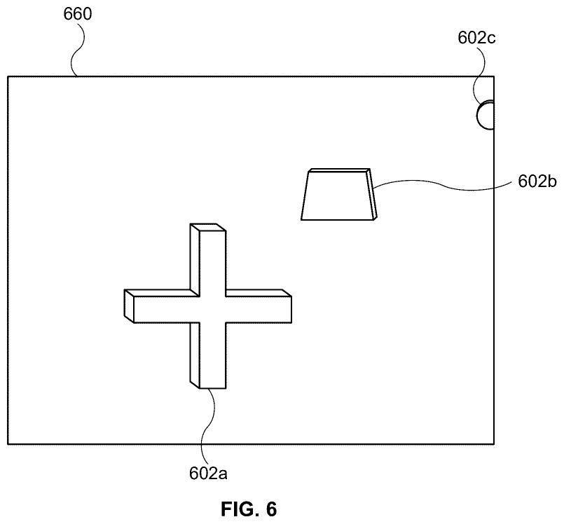

Although the respective pixels of each of objects 102a, 102b, and 102c are generally translated in the same direction, the respective pixels of each of the objects 102a, 102b, and 102c may be translated by different distances. For example, the object 102a (represented by its pixels) are translated by a distance 544a and the object 102b (represented by its pixels) is translated by a distance 544b. As shown, the distance 544b is less than the distance 544a. Based on the depth of the pixels of the object 102a being less than the depth of the pixels of the object 102b, the object 102a is perceived as being closer to the eye 542. Based on Eq. 1, the distance 544a (a component of the disparity) is greater than the distance 544b. Also, the object 102c (represented by its pixels) is translated by a distance (not shown in FIG. 6) that is less than each of the distance 544a and the distance 544b.

Also, as shown in the enlarged view, when the object 102c, near a border 552 of the frame 500, is translated in the direction of the arrow 540, an additional portion or region of the object 102c may be revealed. For example, a portion 554 of the object 102c may be revealed based on the object 102c moving away from the border 552. However, the portion 554 may not be generated via operations, such as backward warping, as the portion 554 may not be initially in the frame 100 shown in FIG. 1. In this regard, an inpainting operation may be performed to fill in the section 556 of the object 102c. In this regard, the inpainting operation, may fill in gaps of missing pixels associated with section 556 by analyzing surrounding pixels to determine the color and brightness of the new pixels to apply to section 556. In some examples, the spatial transform network 220 may generate a mask for the inpainting operation. In some other examples, the spatial 3D component 947, the spatial 3D component 1098 and/or the machine learning model(s) 1330 may perform the inpainting operation.

Referring to FIGS. 4 and 5, the disparity is the sum the distances moved in each direction of an object. For example, the disparity of the object 102a is the sum of the distance 444a (shown in FIG. 4) and the distance 544a (shown in FIG. 5). The disparity of the object 102a (being the closest object) is greater than the disparity of the object 102b, and each of the respective disparities of the objects 102a and 102b is greater than the disparity of the object 102c. The disparity of the object 102a may be the closest object since disparity may be inversely proportionate to the distance of an object.

FIG. 6 illustrates a plan view of an example of a 3D representation 660 of the objects, in accordance with aspects of the present disclosure. The 3D representation 660 is based on a combination of the frame 400 (shown in FIG. 4) and the frame 500 (shown in FIG. 5). As described above, the frame 400 may be associated with the left eye frame and the frame 500 may be associated with a right eye frame. As shown, an object 602a is a 3D representation of the object 102a (shown in FIG. 1), an object 602b is a 3D representation of the object 102a (shown in FIG. 1), and an object 602c is a 3D representation of the object 102c (shown in FIG. 1). Accordingly, when viewing the 3D representation, the objects 602a, 602b, and 602c appear to have depth (e.g., 3D depth) to users. For example, in an instance in which a user views both the frame 400 and the frame 500 (e.g., at or near the same instance/time, simultaneously), the stereo views of the frames 400 and 500 may appear as having perceived depth (e.g., 3D depth) and may appear combined to the eyes (e.g., the right and left eyes) of the user as the 3D representation 600, even though the frames 400 and 500 may be separate and distinct frames.

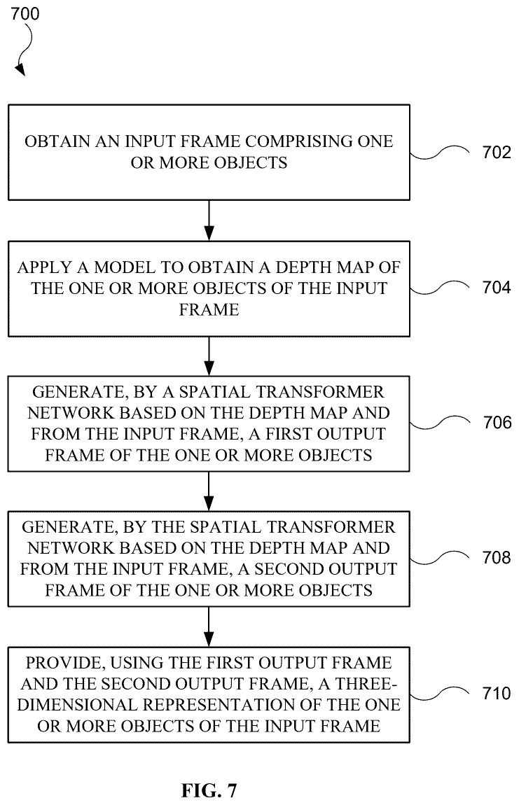

FIG. 7 illustrates an example of a flowchart 700 illustrating operations for devices that may utilize a 2D frame to generate 3D representation, in accordance with aspects of the present disclosure. At block 702, an input frame comprising one or more objects is obtained. The input frame may be a 2D input frame. At block 704, a model is applied to obtain a depth map of the one or more objects of the input frame. In some examples, the model may be a portion/subset of the machine learning model(s) 1330. In some other examples, the model may be the 3D spatial component 948, or the 3D spatial component 1098. At block 706, a first output frame of the one or more objects is generated based on the depth map and from the input frame. The first output frame may be a left eye frame (e.g., eye frame 400). At block 708, a second output frame of the one or more objects is generated based on the depth map and from the input frame. The second output frame may be a right eye frame (e.g., eye frame 500). At block 710, a three-dimensional representation of the one or more objects of the input frame is provided using the first output frame and the output frame image.

### Exemplary System Architecture

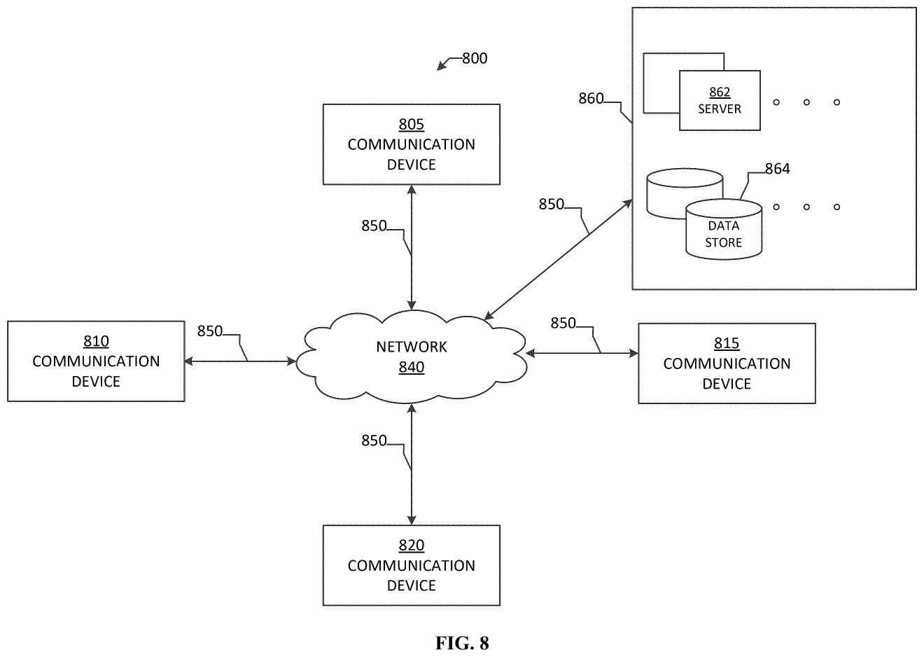

Reference is now made to FIG. 8, which is a block diagram of a system according to exemplary embodiments. As shown in FIG. 8, the system 800 may include one or more communication devices 805, 810, 815 and 820 and a network device 860. Additionally, the system 800 may include any suitable network such as, for example, network 840. In some examples, the network 840 may be a Metaverse network. In other examples, the network 840 may be any suitable network capable of provisioning content and/or facilitating communications among entities within, or associated with the network. As an example and not by way of limitation, one or more portions of network 840 may include an ad hoc network, an intranet, an extranet, a virtual private network (VPN), a local area network (LAN), a wireless LAN (WLAN), a wide area network (WAN), a wireless WAN (WAN), a metropolitan area network (MAN), a portion of the Internet, a portion of the Public Switched Telephone Network (PSTN), a cellular telephone network, or a combination of two or more of these. Network 840 may include one or more networks 840.

Links 850 may connect the communication devices 805, 810, 815 and 820 to network 840, network device 860 and/or to each other. This disclosure contemplates any suitable links 850. In some exemplary embodiments, one or more links 850 may include one or more wireline (such as for example Digital Subscriber Line (DSL) or Data Over Cable Service Interface Specification (DOKSAS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 850 may each include an ad hoc network, an intranet, an extranet, a VPN, a LAN, a WLAN, a WAN, a WAN, a MAN, a portion of the Internet, a portion of the PSTN, a cellular technology-based network, a satellite communications technology-based network, another link 850, or a combination of two or more such links 850. Links 850 need not necessarily be the same throughout system 800. One or more first links 850 may differ in one or more respects from one or more second links 850.

In some exemplary embodiments, communication devices 805, 810, 815, 820 may be electronic devices including hardware, software, or embedded logic components or a combination of two or more such components and capable of carrying out the appropriate functionalities implemented or supported by the communication devices 805, 810, 815, 820. As an example, and not by way of limitation, the communication devices 805, 810, 815, 820 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 805, 810, 815, 820 may enable one or more users to access network 840. The communication devices 805, 810, 815, 820 may enable a user(s) to communicate with other users at other communication devices 805, 810, 815, 820.

Network device 860 may be accessed by the other components of system 800 either directly or via network 840. As an example and not by way of limitation, communication devices 805, 810, 815, 820 may access network device 860 using a web browser or a native application associated with network device 860 (e.g., a mobile social-networking application, a messaging application, another suitable application, or any combination thereof) either directly or via network 840. In particular exemplary embodiments, network device 860 may include one or more servers 862. Each server 862 may be a unitary server or a distributed server spanning multiple computers or multiple datacenters. Servers 862 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 862 may include hardware, software, or embedded logic components or a combination of two or more such components for carrying out the appropriate functionalities implemented and/or supported by server 862. In particular exemplary embodiments, network device 860 may include one or more data stores 864. Data stores 864 may be used to store various types of information. In particular exemplary embodiments, the information stored in data stores 864 may be organized according to specific data structures. In particular exemplary embodiments, each data store 864 may be a relational, columnar, correlation, or other suitable database. Although this disclosure describes or illustrates particular types of databases, this disclosure contemplates any suitable types of databases. Particular exemplary embodiments may provide interfaces that enable communication devices 805, 810, 815, 820 and/or another system (e.g., a third-party system) to manage, retrieve, modify, add, or delete, the information stored in data store 864.

Network device 860 may provide users of the system 800 the ability to communicate and interact with other users. In particular exemplary embodiments, network device 860 may provide users with the ability to take actions on various types of items or objects, supported by network device 860. In particular exemplary embodiments, network device 860 may be capable of linking a variety of entities. As an example and not by way of limitation, network device 860 may enable users to interact with each other as well as receive content from other systems (e.g., third-party systems) or other entities, or to allow users to interact with these entities through an application programming interfaces (API) or other communication channels.

It should be pointed out that although FIG. 8 shows one network device 860 and four communication devices 805, 810, 815 and 820, any suitable number of network devices 860 and communication devices 805, 810, 815 and 820 may be part of the system of FIG. 8 without departing from the spirit and scope of the present disclosure.

### Exemplary Communication Device

FIG. 9 illustrates a block diagram of an exemplary hardware/software architecture of a communication device such as, for example, user equipment (UE) 930. In some exemplary aspects, the UE 930 may be any of communication devices 805, 810, 815, 820. In some exemplary aspects, the UE 930 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 9, the UE 930 (also referred to herein as node 930) may include a processor 932, non-removable memory 944, removable memory 946, a speaker/microphone 938, a keypad 940, a display, touchpad, and/or user interface(s) 942, a power source 948, a global positioning system (GPS) chipset 950, other peripherals 952, and a 3D spatial component 947. In some exemplary aspects, the display, touchpad, and/or user interface(s) 942 may be referred to herein as display/touchpad/user interface(s) 942. The display/touchpad/user interface(s) 942 may include a user interface capable of presenting one or more content items and/or capturing input of one or more user interactions/actions associated with the user interface. The power source 948 may be capable of receiving electric power for supplying electric power to the UE 930. For example, the power source 948 may include an alternating current to direct current (AC-to-DC) converter allowing the power source 948 to be connected/plugged to an AC electrical receptable and/or Universal Serial Bus (USB) port for receiving electric power. The UE 930 may also include a camera 954. In an exemplary embodiment, the camera 954 may be a smart camera configured to sense images/video appearing within one or more bounding boxes. The UE 930 may also include communication circuitry, such as a transceiver 934 and a transmit/receive element 936. It will be appreciated the UE 930 may include any sub-combination of the foregoing elements while remaining consistent with an embodiment.

The processor 932 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 932 may execute computer-executable instructions stored in the memory (e.g., non-removable memory 944 and/or removable memory 946) of the node 930 in order to perform the various required functions of the node. For example, the processor 932 may perform signal coding, data processing, power control, input/output processing, and/or any other functionality that enables the node 930 to operate in a wireless or wired environment. The processor 932 may run application-layer programs (e.g., browsers) and/or radio access-layer (RAN) programs and/or other communications programs. The processor 932 may also perform security operations such as authentication, security key agreement, and/or cryptographic operations, such as at the access-layer and/or application layer for example.

The processor 932 is coupled to its communication circuitry (e.g., transceiver 934 and transmit/receive element 936). The processor 932, through the execution of computer executable instructions, may control the communication circuitry in order to cause the node 930 to communicate with other nodes via the network to which it is connected.

The transmit/receive element 936 may be configured to transmit signals to, or receive signals from, other nodes or networking equipment. For example, in an exemplary embodiment, the transmit/receive element 936 may be an antenna configured to transmit and/or receive radio frequency (RF) signals. The transmit/receive element 936 may support various networks and air interfaces, such as wireless local area network (WLAN), wireless personal area network (WPAN), cellular, and the like. In yet another exemplary embodiment, the transmit/receive element 936 may be configured to transmit and/or receive both RF and light signals. It will be appreciated that the transmit/receive element 936 may be configured to transmit and/or receive any combination of wireless or wired signals.

The transceiver 934 may be configured to modulate the signals that are to be transmitted by the transmit/receive element 936 and to demodulate the signals that are received by the transmit/receive element 936. As noted above, the node 930 may have multi-mode capabilities. Thus, the transceiver 934 may include multiple transceivers for enabling the node 930 to communicate via multiple radio access technologies (RATs), such as universal terrestrial radio access (UTRA) and Institute of Electrical and Electronics Engineers (IEEE 802.11), for example.

The processor 932 may access information from, and store data in, any type of suitable memory, such as the non-removable memory 944 and/or the removable memory 946. For example, the processor 932 may store session context in its memory, (e.g., non-removable memory 944 and/or removable memory 946) as described above. The non-removable memory 944 may include RAM, ROM, a hard disk, or any other type of memory storage device. The removable memory 946 may include a subscriber identity module (SIM) card, a memory stick, a secure digital (SD) memory card, and the like. In other exemplary embodiments, the processor 932 may access information from, and store data in, memory that is not physically located on the node 930, such as on a server or a home computer.

The processor 932 may receive power from the power source 948, and may be configured to distribute and/or control the power to the other components in the node 930. The power source 948 may be any suitable device for powering the node 930. For example, the power source 948 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 932 may also be coupled to the GPS chipset 950, which may be configured to provide location information (e.g., longitude and latitude) regarding the current location of the node 930. It will be appreciated that the node 930 may acquire location information by way of any suitable location-determination method while remaining consistent with an exemplary embodiment.

In some exemplary aspects, the spatial 3D component 947 may function and/or operate in an analogous manner as system 210. In this regard, for example, the spatial 3D component 947 may access (e.g., from camera 954, camera 1116, etc.), or may itself capture, one or more images/videos such as 2D images/videos (e.g., of a scene(s)) and may convert the 2D images/videos to 3D images/videos, as described more fully below.

### Exemplary Computing System

FIG. 10 is a block diagram of an exemplary computing system 1000. In some exemplary embodiments, the network device 160 may be a computing system 1000. In some other exemplary embodiments, the system 210 may be a computing system 1000. The computing system 1000 may comprise a computer or server and may be controlled primarily by computer readable instructions, which may be in the form of software, wherever, or by whatever means such software is stored or accessed. Such computer readable instructions may be executed within a processor, such as central processing unit (CPU) 1091, to cause computing system 1000 to operate. In many workstations, servers, and personal computers, central processing unit 1091 may be implemented by a single-chip CPU called a microprocessor. In other machines, the central processing unit 91 may comprise multiple processors. Coprocessor 1081 may be an optional processor, distinct from main CPU 1091, that performs additional functions or assists CPU 1091.

In operation, CPU 1091 fetches, decodes, and executes instructions, and transfers information to and from other resources via the computer's main data-transfer path, system bus 1080. Such a system bus connects the components in computing system 1000 and defines the medium for data exchange. System bus 1080 typically includes data lines for sending data, address lines for sending addresses, and control lines for sending interrupts and for operating the system bus. An example of such a system bus 1080 is the Peripheral Component Interconnect (PCI) bus.

Memories coupled to system bus 1080 include RAM 1082 and ROM 1093. Such memories may include circuitry that allows information to be stored and retrieved. ROMs 1093 generally contain stored data that cannot easily be modified. Data stored in RAM 1082 may be read or changed by CPU 1091 or other hardware devices. Access to RAM 1082 and/or ROM 1093 may be controlled by memory controller 1092. Memory controller 1092 may provide an address translation function that translates virtual addresses into physical addresses as instructions are executed. Memory controller 1092 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 1000 may contain peripherals controller 1083 responsible for communicating instructions from CPU 1091 to peripherals, such as printer 1094, keyboard 1084, mouse 1095, and disk drive 1085.

Display 1086, which is controlled by display controller 1096, may be used to display visual output generated by computing system 1000. Such visual output may include text, graphics, animated graphics, and video. The display 1086 may also include, or be associated with a user interface. The user interface may be capable of presenting one or more content items and/or capturing input of one or more user interactions associated with the user interface. Display 1086 may be implemented with a cathode-ray tube (CRT)-based video display, a liquid-crystal display (LCD)-based flat-panel display, gas plasma-based flat-panel display, or a touch-panel. Display controller 1096 includes electronic components required to generate a video signal that is sent to display 1086.

In some exemplary aspects, the computing system 1000 may include a spatial 3D component 1098 which may access, or capture, one or more images such as for example 2D images/videos and may convert the 2D images/videos to 3D images/videos, as described more fully below. In some examples the computing system 1000 may receive, access, or obtain the 2D images/videos from another communication device(s) (e.g., UE 900, artificial reality system 1100, HMD 1200) and may convert the 2D images/videos to 3D images/videos and may send the converted 3D images/videos to the other communication device(s).

Further, computing system 1000 may contain communication circuitry, such as for example a network adaptor 1097, that may be used to connect computing system 1000 to an external communications network, such as network 912 of FIG. 9, to enable the computing system 1000 to communicate with other nodes (e.g., UE 930) of the network.

### Exemplary Artificial Reality System

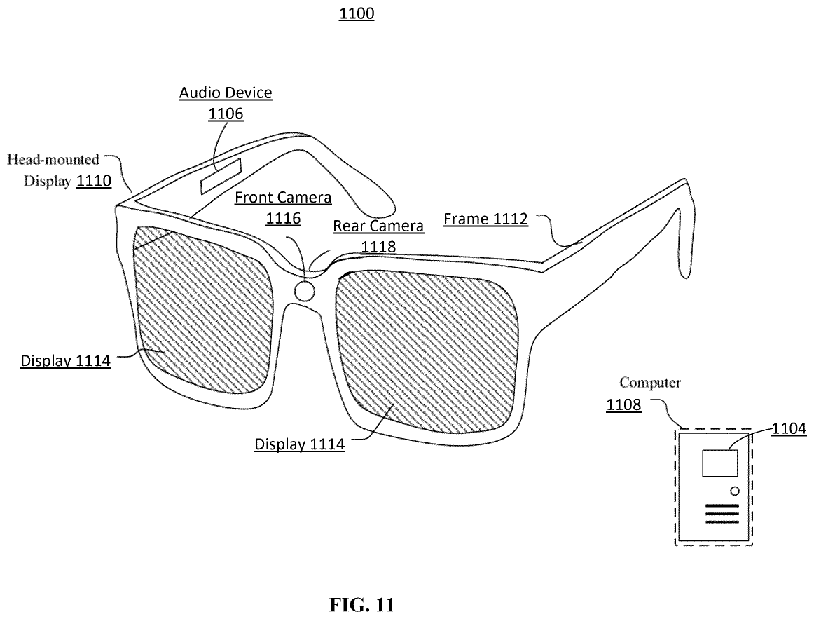

FIG. 11 illustrates an example artificial reality system 1100. The artificial reality system 1100 may include a head-mounted display (HMD) 1110 (e.g., smart glasses and/or augmented/virtual reality device) comprising a frame 1112, one or more displays 1114, a computing device 1108 (also referred to herein as computer 1108) and a controller 1104. In some examples, the HMD 1110 may capture content (e.g., images/videos) associated with a real world environment in the field of view of one or more cameras (e.g., cameras 1116, 1118) of the artificial reality system 1100. The displays 1114 may be transparent or translucent allowing a user wearing the HMD 1110 to look through the displays 1114 to see the real world (e.g., real world environment and/or an AR/VR/MR environment) and displaying visual artificial reality content to the user at the same time. The HMD 1110 may include an audio device 1106 (e.g., speakers/microphones) that may provide audio artificial reality content to users. The HMD 1110 may include one or more cameras 1116, 1118 which may capture images and/or videos of environments. In one exemplary embodiment, the HMD 1110 may include a camera(s) 1118 which may be a rear-facing camera tracking movement and/or gaze of a user's eyes.

One of the cameras 1116 may be a forward-facing camera capturing images and/or videos of the environment that a user wearing the HMD 1110 may view. The camera(s) 1116 may also be referred to herein as a front camera(s) 1116. The HMD 1110 may include an eye tracking system to track the vergence movement of the user wearing the HMD 1110. In one exemplary embodiment, the camera(s) 1118 may be the eye tracking system. In some exemplary embodiments, the camera(s) 1118 may be one camera configured to view at least one eye of a user to capture a glint image(s) (e.g., and/or glint signals). The camera(s) 1118 may also be referred to herein as a rear camera(s) 1118. The HMD 1110 may include a microphone of the audio device 1106 to capture voice input from the user. The artificial reality system 1100 may further include a controller 1104 comprising a trackpad and one or more buttons. The controller 1104 may receive inputs from users and relay the inputs to the computing device 1108. The controller 1104 may also provide haptic feedback to one or more users. In some example aspects, the controller 1104 may perform functions/operations as the functions/operations of the 3D spatial component 947 and/or the 3D spatial component 1098. For example, the camera 1116 may be configured to capture, and/or access 2D images/videos and the controller 1104 may convert the 2D images/videos to 3D images/videos. In some examples, the controller 1104 may provide the captured accessed 2D images to a network device (e.g., computing system 1000) and may receive the converted 3D images/videos from the network device (e.g., 3D spatial component 1098 of the computing system 1000). The computing device 1108 may be connected to the HMD 1110 and the controller 1104 through cables or wireless connections. The computing device 1108 may control the HMD 1110 and the controller 1104 to provide the augmented reality content to and receive inputs from one or more users. In some example aspects, the controller 1104 may be a standalone controller or integrated within the HMD 1110. The computing device 1108 may be a standalone host computer device, an on-board computer device integrated with the HMD 1110, a mobile device, or any other hardware platform capable of providing artificial reality content to and receiving inputs from users. In some exemplary aspects, the HMD 1110 may include an artificial reality system/virtual reality system.

### Another Exemplary Artificial Reality System

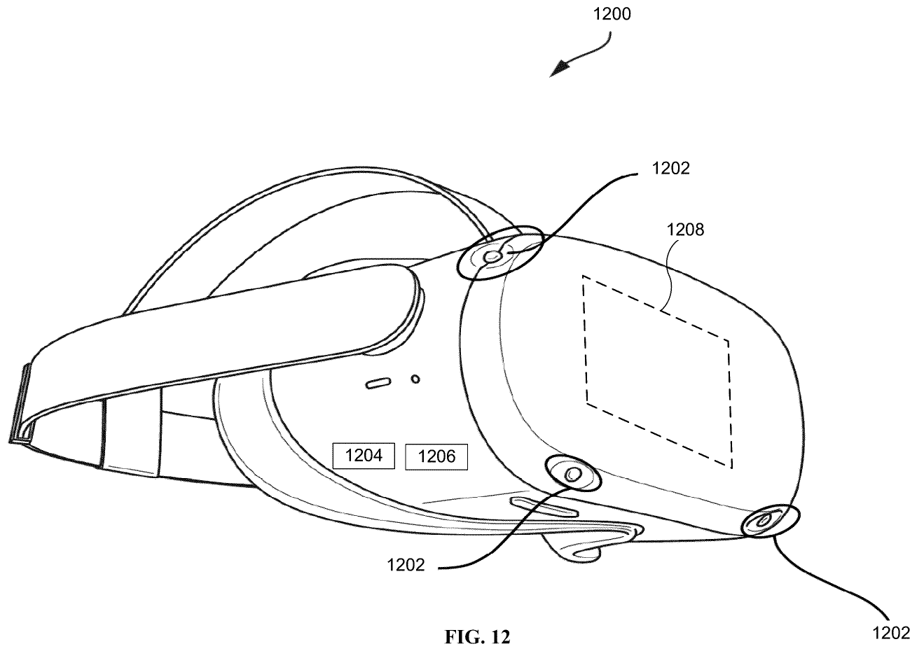

FIG. 12 illustrates another example of an artificial reality system including a head-mounted display (HMD) 1200, image sensors 1202 mounted to (e.g., extending from) HMD 1200, according to at least one example aspect of the present disclosure. In some examples of the present disclosure, the HMD 1200 may be an example of artificial reality system 1200 and/or HMD 1210. In some example aspects, image sensors 1202 may be mounted on and protruding from a surface (e.g., a front surface, a corner surface, etc.) of HMD 1200. In some exemplary aspects, HMD 1200 may include an artificial reality system/virtual reality system. In an exemplary aspect, image sensors 1202 may include, but are not limited to, one or more sensors (e.g., cameras 1116, 1118, an audio device 1106, etc.), a memory 1206 (e.g., RAM, ROM) and a processor 1204 (e.g., a controller (e.g., controller 1404)). In some example aspects, the processor 1204 may perform functions/operations as the functions/operations of the 3D spatial component 947 and/or the 3D spatial component 1098. For example, an image sensor(s) 1202 may be configured to capture, and/or access 2D images/videos and the processor 1204 may convert the 2D images/videos to 3D images/videos. In some examples, the processor 1204 may provide the captured accessed 2D images to a network device (e.g., computing system 1000) and may receive the converted 3D images/videos from the network device (e.g., 3D spatial component 1098 of the computing system 1000). In exemplary aspects, a compressible shock absorbing device may be mounted on image sensors 1202. The shock absorbing device may be configured to substantially maintain the structural integrity of image sensors 1202 in case an impact force is imparted on image sensors 1202. In some exemplary embodiments, image sensors 1202 may protrude from a surface (e.g., the front surface) of HMD 1200 so as to increase a field of view of image sensors 1202. In some examples, image sensors 1202 may be pivotally and/or translationally mounted to HMD 1200 to pivot image sensors 1202 at a range of angles and/or to allow for translation in multiple directions, in response to an impact. For example, image sensors 1202 may protrude from the front surface of HMD 1200 so as to give image sensors 1202 at least a 180 degree field of view of objects (e.g., a hand, a user, a surrounding real-world environment, etc.).

The HMD 1200 may further include a display 1208 designed to present visual information based on an artificial reality system application(s) (e.g., VR) and/or AR application(s) as well as mixed reality application(s). Additionally or alternatively, the display 1208 may be coupled (e.g., electrically coupled) to each of the image sensors 1202, and may present visual information in the form of an external environment, as captured by one or more of the image sensors 1202. Using one or more of the image sensors 1202, the HMD 1200 may capture content and/or media in the environment and may present the content/media onto the display 1208.

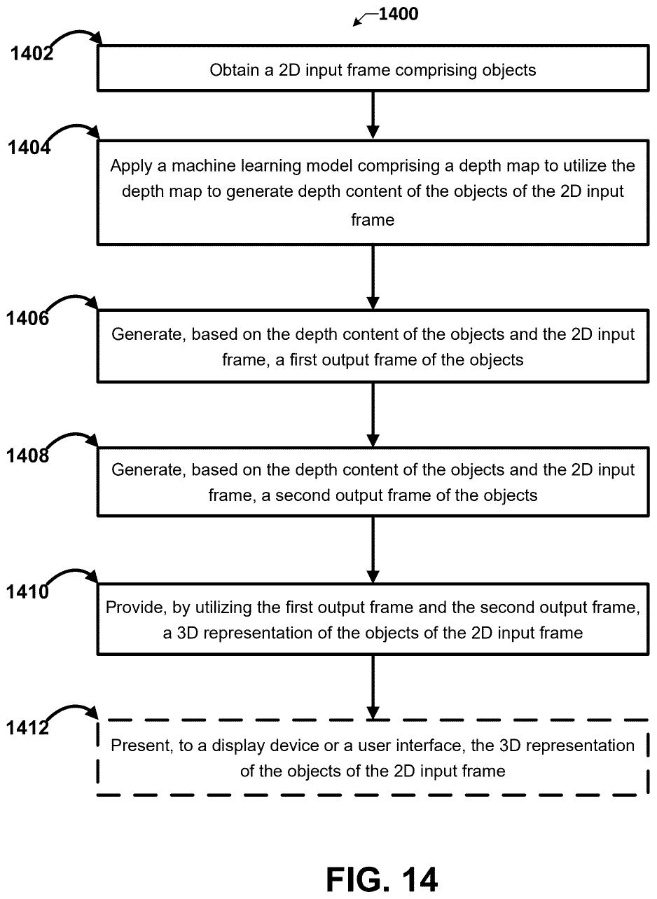

FIG. 13 illustrates an example of a machine learning framework 1300 including machine learning model(s) 1330 and a training database 1350, in accordance with one or more examples of the present disclosure. The training database 1350 may store training data 1320. In some examples, the machine learning framework 1300 may be hosted locally in a computing device or hosted remotely. By utilizing the training data 1320 of the training database 1350, the machine learning framework 1300 may train the machine learning model(s) 1330 to perform one or more functions, described herein, of the machine learning model(s) 1330. In some examples, the machine learning model(s) 1330 may be stored in a computing device. For example, the machine learning model(s) 1330 may be embodied within a communication device (e.g., UE 930). In some other examples, the machine learning model(s) 1330 may be embodied within another device (e.g., computing system 1000, artificial reality system 1100, HMD 1200). Additionally, the machine learning model(s) 1330 may be processed by one or more processors (e.g., processor 932 of FIG. 9, coprocessor 1081 of FIG. 10, controller 1104 of FIG. 11, processor 1204 of FIG. 12). In some examples, the machine learning model(s) 1330 may be associated with operations (or performing operations) of FIG. 3, FIG. 7 and/or FIG. 14. In some other examples, the machine learning model(s) 1330 may be associated with other operations. In some examples, the machine learning model(s) 1330 may be an example of the spatial 3D component 947, and/or the spatial 3D component 1098. In some other examples, the machine learning model(s) 1330 may implement the spatial 3D component 947, and/or the spatial 3D component 1098.

The training data 1320 employed by the machine learning model(s) 1330 may be pre-trained, fixed or updated periodically. Alternatively, the training data 1320 may be updated in real-time based upon the evaluations performed by the machine learning model(s) 1330 in a non-training mode. This may be illustrated by the double-sided arrow connecting the machine learning model(s) 1330 and stored training data 1320 which may be stored in the training database 1350. Some other examples of the training data 1320 may include, but are not limited to, items of content determined as being associated with a network (e.g., the Internet, a social network, etc.), a platform (e.g., system 800), or the like. Other examples of training data 1320 for the machine learning model(s) 1330 may be videos, images, animations, depth maps, disparity maps, warping information/content, inpainting content, AR content, VR content, MR content and/or the like. Additionally, in some examples, the training data 1320 may be associated with publicly available (e.g., non-private) datasets (e.g., associated with a network). In some other examples, the training data 1320 may be synthetic generated data.

In some examples, the machine learning model(s) 1330 may evaluate attributes as training data (e.g., training data 1320) of images, videos, audio, text, pictures, photographs, augmented reality data, animations, dialogue, or other information (e.g., size, shape, orientation, position of an object(s)) obtained by hardware (e.g., sensors, peripherals, etc.). The attributes of any of the above may then be compared with respective attributes of stored training data 1320 (e.g., prestored objects, prestored scenes, etc.). The likelihood of similarity between each of the obtained attributes and the stored training data 1320 (e.g., prestored objects, scenes) may be given/assigned a determined confidence score. In an exemplary aspect, in an instance in which the confidence score satisfies (e.g., equals or exceeds) a predetermined threshold, the attribute(s) may be included in an instruction to convert an image/video (e.g., a 2D image/video), of an object(s), scene(s), or the like, to a 3D image/video.

FIG. 14 illustrates an exemplary process 1400 to facilitate generation of a 3D representation of a video frame based on a 2D input frame. At operation 1402, a device (e.g., UE 900, computing system 1000, artificial reality system 1100, HMD 1200) may obtain a 2D input frame comprising objects. At operation 1404, a device (e.g., UE 900, computing system 1000, artificial reality system 1100, HMD 1200) may apply a machine learning model comprising a depth map to utilize the depth map to generate depth content of the objects of the 2D input frame.

At operation 1406, a device (e.g., UE 900, computing system 1000, artificial reality system 1100, HMD 1200) may generate, based on the depth content of the objects and the 2D input frame, a first output frame of the objects. At operation 1408, a device (e.g., UE 900, computing system 1000, artificial reality system 1100, HMD 1200) may generate, based on the depth content of the objects and the 2D input frame, a second output frame of the objects. At operation 1410 a device (e.g., UE 900, computing system 1000, artificial reality system 1100, HMD 1200) may provide, by utilizing the first output frame and the second output frame, a 3D representation of the objects of the 2D input frame. Optionally, at operation 1412, a device (e.g., UE 900, computing system 1000, artificial reality system 1100, HMD 1200) may present, to a display device or a user interface, the 3D representation of the objects of the 2D input frame.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
obtaining a two-dimensional (2D) input frame comprising objects;
applying a machine learning model comprising a depth map to utilize the depth map to generate depth content of the objects of the 2D input frame;
generating, based on the depth content of the objects and the 2D input frame, a first output frame of the objects;
generating, based on the depth content of the objects and the 2D input frame, a second output frame of the objects; and
providing, by utilizing the first output frame and the second output frame, a three-dimensional (3D) representation of the objects of the 2D input frame.

2. The method of claim 1, further comprising:
presenting, to a display device or a user interface, the 3D representation of the objects of the 2D input frame.

3. The method of claim 2, wherein the presenting the 3D representation of the objects comprises presenting the first output frame and the second output frame to the display device or the user interface while being viewed by eyes of a user.

4. The method of claim 1, wherein:
the obtaining the 2D input frame comprises obtaining a 2D image of the objects, the 2D input frame comprises a 2D input video frame; and
the 3D representation of the objects comprises a 3D output image associated with a 3D output video.

5. The method of claim 1, wherein:
the generating the first output frame comprises generating a left-eye frame; and
the generating the second output frame comprises generating a right-eye frame.

6. The method of claim 1, further comprising:
determining, based on the depth map, a first pixel corresponding to a first object of the objects is at a first depth; and
determining, based on the depth map, a second pixel corresponding to a second object of the objects is at a second depth greater than, or less than, the first depth.

7. The method of claim 6, wherein the generating the first output frame comprises:
translating, in a first direction, the first pixel to a first distance from an initial position of the first object in the 2D input frame; and
translating, in the first direction, the second pixel to a second distance from an initial position of the second pixel in the input frame, the second distance is less than, or greater than, the first distance.

8. The method of claim 6, wherein the generating the second output frame comprises:
translating, in a second direction opposite a first direction, the first pixel to a first distance from the initial position of the first pixel in the input frame; and
translating, in the second direction, the second pixel to a second distance from an initial position of the second pixel in the 2D input frame.

9. The method of claim 1, wherein the generating the first output frame of the objects comprises:
translating pixels of an object of the objects from a first position in the input 2D frame to a second position different from the first position; and
interpolating, based on pixel content in a region of the 2D input frame, pixel values for new pixels at a location corresponding to initial pixels at the first position that are no longer occupied by the initial pixels of the object associated with the second position.

10. The method of claim 9, further comprising:
providing the new pixels to the first position that are no longer occupied by the initial pixels.

11. The method of claim 1, wherein the obtaining the 2D input image comprises capturing the 2D input frame by a head mounted display device, the method further comprising:
presenting, to the head mounted display device, the 3D representation of the objects.

12. An apparatus comprising:
one or more processors; and
at least one memory storing instructions, that when executed by the one or more processors, cause the apparatus to:
obtain a two-dimensional (2D) input frame comprising objects;
apply a machine learning model comprising a depth map to utilize the depth map to generate depth content of the objects of the 2D input frame;
generate, based on the depth content of the objects and the 2D input frame, a first output frame of the objects;
generate, based on the depth content of the objects and the 2D input frame, a second output frame of the objects; and
provide, by utilizing the first output frame and the second output frame, a three-dimensional (3D) representation of the objects of the 2D input frame.

13. The apparatus of claim 12, wherein when the one or more processors further execute the instructions, the apparatus is configured to:
present, to a display device or a user interface, the 3D representation of the objects of the 2D input frame.

14. The apparatus of claim 13, wherein when the one or more processors further execute the instructions, the apparatus is configured to:
perform the present of the 3D representation of the objects by presenting the first output frame and the second output frame to the display device or the user interface while being viewed by eyes of a user.

15. The apparatus of claim 12, wherein when the one or more processors further execute the instructions, the apparatus is configured to:
perform the obtain of the 2D input frame by obtaining a 2D image of the objects, the 2D input frame comprises a 2D input video frame; and
the 3D representation of the objects comprises a 3D output image associated with a 3D output video.

16. The apparatus of claim 12, wherein when the one or more processors further execute the instructions, the apparatus is configured to:
perform the generate of the first output frame by generating a left-eye frame; and
perform the generate of the second output frame comprises generating a right-eye frame.

17. The apparatus of claim 12, wherein when the one or more processors further execute the instructions, the apparatus is configured to:
determine, based on the depth map, a first pixel corresponding to a first object of the objects is at a first depth; and
determine, based on the depth map, a second pixel corresponding to a second object of the objects is at a second depth greater than, or less than, the first depth.

18. A non-transitory computer-readable medium storing instructions that, when executed, cause:
obtaining a two-dimensional (2D) input frame comprising objects;
applying a machine learning model comprising a depth map to utilize the depth map to generate depth content of the objects of the 2D input frame;
generating, based on the depth content of the objects and the 2D input frame, a first output frame of the objects;
generating, based on the depth content of the objects and the 2D input frame, a second output frame of the objects; and
providing, by utilizing the first output frame and the second output frame, a three-dimensional (3D) representation of the objects of the 2D input frame.

19. The computer-readable medium of claim 18, wherein the instructions, when executed, further cause:
presenting, to a display device or a user interface, the 3D representation of the objects of the 2D input frame.

20. The computer-readable medium of claim 19, wherein the instructions, when executed, further cause:
performing the presenting of the 3D representation of the objects by presenting the first output frame and the second output frame to the display device or the user interface while being viewed by eyes of a user.
